(19) United States
(12) Patent Application Publication
(10) Pub. No.: US 2025/0278453 A1
(43) Pub. Date: Sep. 4, 2025

(54) ARITHMETIC DEVICE, INFORMATION PROCESSING APPARATUS, AND METHOD FOR CONTROLLING ARITHMETIC DEVICE

(71) Applicant: Fujitsu Limited, Kawasaki-shi (JP)

(72) Inventor: Yosuke Nakamura, Kawasaki (JP)

(73) Assignee: Fujitsu Limited, Kawasaki-shi (JP)

(21) Appl. No.: 18/977,333

(22) Filed: Dec. 11, 2024

(30) Foreign Application Priority Data
Mar. 4, 2024 (JP) 2024-032510

(51) Int. Cl. G06F 17/16

(52) U.S. Cl. CPC G06F 17/16

(57) ABSTRACT

An arithmetic device includes: a memory configured to receive and store data for a matrix arithmetic operation including individual arithmetic operations; a systolic array in which arithmetic operators are arranged in a matrix, and configured to execute the matrix arithmetic operation by causing the arithmetic operators to perform different individual arithmetic operations; and a processor configured to, upon receiving a processing request for the matrix arithmetic operation, calculate an excess arithmetic operator number which is a number of arithmetic operators that exceed an upper limit number to be caused to newly start operation among increments of the arithmetic operators to be caused to perform the individual arithmetic operations, pre-operate the arithmetic operators based on the excess arithmetic operator number based on start of data reception of the memory, and cause the systolic array to execute the matrix arithmetic operation based on the data when the memory completes the data reception.

### CROSS-REFERENCE TO RELATED APPLICATION

This application is based upon and claims the benefit of priority of the prior Japanese Patent Application No. 2024-32510, filed on Mar. 4, 2024, the entire contents of which are incorporated herein by reference.

### FIELD

The embodiment discussed herein is related to an arithmetic device, an information processing apparatus, and a method for controlling an arithmetic device.

### BACKGROUND

In recent years, artificial intelligence (AI) has attracted attention in various fields. In such an environment, there is a growing desire for AI to perform complicated processing at a high speed, and performance requested for hardware to operate AI is greatly increasing. For example, a current trend in a requested amount of arithmetic operations for AI is at a level far exceeding performance improvement in the related art, reaching a level at which a number of arithmetic operators is expanded to limits of heat and power, and increasing exponentially.

Japanese Laid-open Patent Publication No. 2021-177366 is disclosed as related art.

### SUMMARY

According to an aspect of the embodiments, an arithmetic device includes: a memory configured to sequentially receive and store data to be used for a matrix arithmetic operation that includes a plurality of individual arithmetic operations; a systolic array in which a plurality of arithmetic operators are arranged in a matrix, and configured to execute the matrix arithmetic operation by causing the arithmetic operators to perform different individual arithmetic operations in order; and a processor configured to, upon receiving a processing request for the matrix arithmetic operation, calculate, for each cycle, an excess arithmetic operator number which is a number of arithmetic operators that exceed an upper limit number to be caused to newly start operation among increments of the arithmetic operators to be caused to perform the individual arithmetic operations for each cycle, pre-operate the arithmetic operators based on the excess arithmetic operator number based on start of data reception of the memory, and cause the systolic array to execute the matrix arithmetic operation based on the data held by the memory when the memory completes the data reception.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a processor equipped with a systolic array;

FIG. 2 is a diagram illustrating a behavior of the systolic array;

FIG. 3 is a diagram for describing idling control by a control unit;

FIG. 4 is a diagram illustrating an example of an outline of an idling order;

FIG. 5 is a diagram illustrating an example of a specific idling order;

FIG. 6 is a sequence diagram of arithmetic operation execution by the processor according to the embodiment;

FIG. 7 is a flowchart of the idling control;

FIG. 8 is a diagram illustrating a comparison of a time taken to execute an arithmetic operation between the processor according to the embodiment and a processor that does not perform idling; and

FIG. 9 is a diagram illustrating an example of hardware of an information processing apparatus equipped with the processor according to the embodiment.

### DESCRIPTION OF EMBODIMENTS

Various kinds of hardware for operating AI have been proposed in response to such a rapid increase in the requested amount of arithmetic operations. As dedicated hardware, for example, there is an arithmetic device using a configuration called a systolic array (SA) in which arithmetic operators are arranged in a tile shape. A complex of the arithmetic operators configured by the systolic array is simply referred to as a “systolic array”.

The systolic array makes use of a fact that processing performed by each arithmetic operator is regular in a case of a matrix arithmetic operation or the like, and cyclically flows data and performs an arithmetic operation when two pieces of data are prepared in the flow. In the systolic array, resources may be concentrated, and arithmetic operation density is improved. On the other hand, there is also an aspect that the sufficiency of quality assurance and continuous operability from a viewpoint of a product is not sufficiently examined with respect to chips configuring the systolic array.

For example, as a technology related to the systolic array, a technology for improving a speed of machine learning by selectively controlling an output destination in each pipeline stage in a pipeline for performing systolic processing has been proposed.

However, since the systolic array is equipped with a very large number of arithmetic operators, operation timing control of each arithmetic operator is important, and an abnormality may occur depending on the operation timing. For example, when many arithmetic operators in the circuit start operating at the same time, power consumption rapidly increases, and a temporary decrease in a power supply voltage called an IR drop occurs. When the IR drop occurs due to a rapid change in the number of operating arithmetic operators and a supply current and a supply voltage become unstable, noise occurs. In this way, when a specified voltage is not guaranteed in all the arithmetic operators, there is a possibility that a storage result or an arithmetic operation result is damaged and an error occurs.

As a method for avoiding a voltage shortage at the time of the rapid increase in the operating number, a method of suppressing an increase in the voltage by limiting a newly operating number is considered. However, when the newly operating number is limited, it is possible to avoid the voltage shortage at the time of the rapid increase in the operating number, but it is difficult to operate a sufficient number of arithmetic operators for an arithmetic operation to be executed, and there is a possibility that an execution timing of the arithmetic operation is delayed. The delay in the execution timing of the arithmetic operation leads to a decrease in the performance of the systolic array as a whole, which causes a problem in that desired performance is not satisfied.

Even in the technology of selecting and controlling the output destination in each pipeline stage of the pipeline that performs the systolic processing, a voltage rise due to the new operation of the arithmetic operator is not considered, and it is difficult to improve reliability of the systolic array.

In view of the above, an object of the disclosed technology is to provide an arithmetic device, an information processing apparatus, and a method for controlling an arithmetic device that improve reliability while maintaining processing performance.

Hereinafter, an embodiment of an arithmetic device, an information processing apparatus, and a method for controlling an arithmetic device disclosed in the present application will be described in detail with reference to the drawings. The arithmetic device, the information processing apparatus, and the method for controlling an arithmetic device disclosed in the present application are not limited to the following embodiment.

### Embodiment

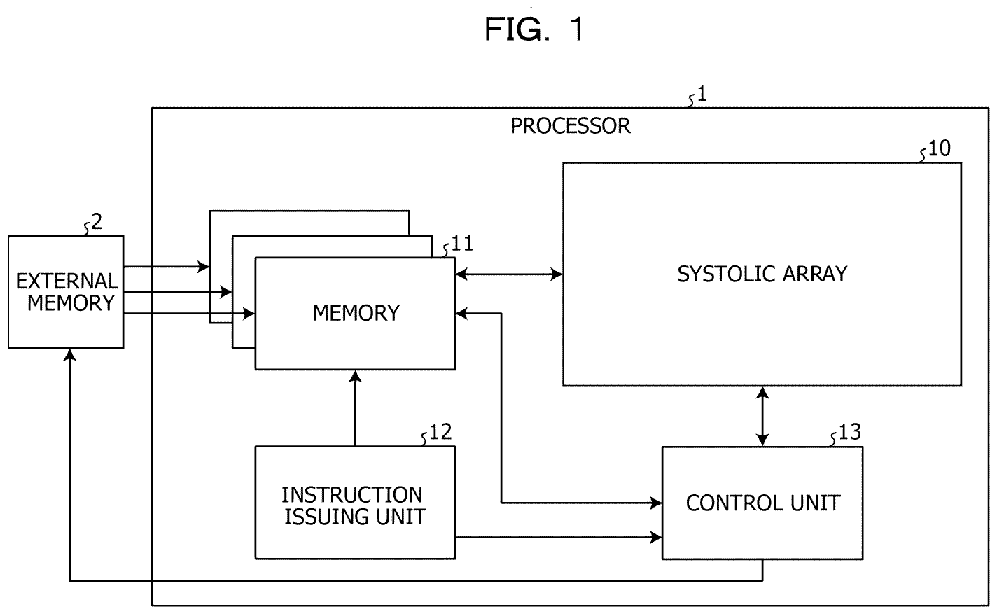

FIG. 1 is a block diagram of a processor equipped with a systolic array. As illustrated in FIG. 1, a processor 1 which is an arithmetic device includes a systolic array 10, a plurality of memories 11, an instruction issuing unit 12, and a control unit 13.

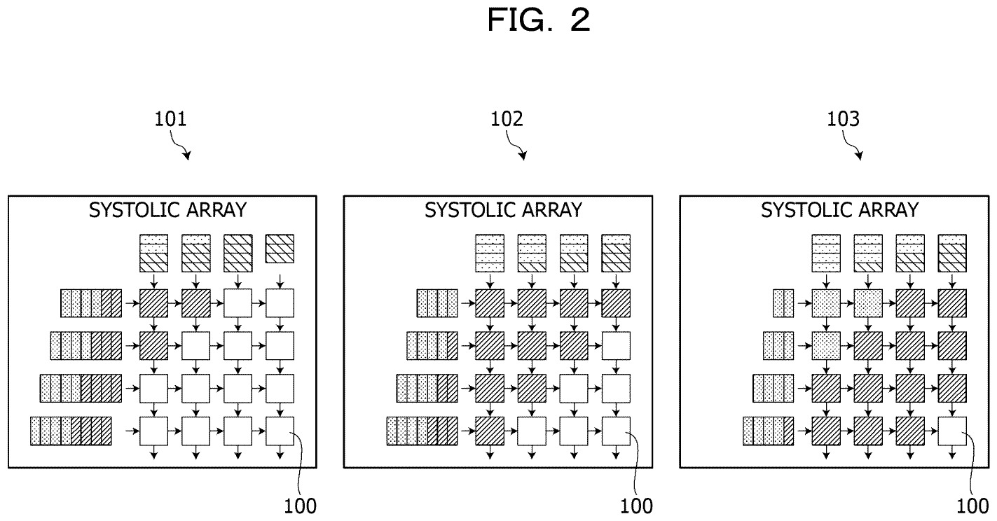

FIG. 2 is a diagram illustrating a behavior of the systolic array. The systolic array 10 is equipped with a plurality of arithmetic operators 100. The plurality of arithmetic operators 100 are linearly arranged in vertical and horizontal directions and are arranged in a tile shape so as to form a matrix. The matrix formed by the arithmetic operators 100 is referred to as an “arithmetic operation matrix”.

Data is input from an end on a same side of each column of the arithmetic operation matrix formed by the arithmetic operators 100. Data is input from an end on a same side of each row of the arithmetic operation matrix formed by the arithmetic operators 100. For example, in FIG. 2, data is input to each column from an upper side of the drawing, and data is input to each row from a left side of the drawing.

In accordance with FIG. 2, a side on which data is first input in a column direction of the arithmetic operation matrix formed by the arithmetic operators 100 is referred to as an upper side, an opposite side thereof is referred to as a lower side, a side on which data is first input in a row direction of the arithmetic operation matrix is referred to as a left side, and an opposite side thereof is referred to as a right side.

The arithmetic operator 100 receives an input of data from the upper side and from the left side. For example, an arithmetic operator 100 at a left end receives an input of data from the left side, from a buffer memory. An arithmetic operator 100 at an upper end receives an input of data from the upper side, from a buffer memory. In other cases, each arithmetic operator 100 receives the input of data from the left side, from an arithmetic operator 100 adjacent on the left side. Each arithmetic operator 100 receives the input of data from the upper side, from an arithmetic operator 100 adjacent on the upper side.

When both the data from the left side and the data from the upper side are acquired, the arithmetic operator 100 executes an arithmetic operation by using the respective pieces of data in one cycle. After an end of the arithmetic operation, the arithmetic operator 100 outputs an arithmetic operation result to an arithmetic operator 100 adjacent on the right side and an arithmetic operator 100 adjacent on the lower side. The arithmetic operator 100 propagates the arithmetic operation result to adjacent arithmetic operators 100 in each cycle. However, a last arithmetic operator 100 of each row and each column of the arithmetic operation matrix outputs the arithmetic operation result of each row or column to an outside.

For example, a case of a 4×4 arithmetic operation matrix illustrated in FIG. 2 will be described. In FIG. 2, arithmetic operators 100 to which an oblique line pattern is attached are arithmetic operators 100 that execute an arithmetic operation. Arithmetic operators 100 to which no pattern is attached are arithmetic operators 100 that are not executing an arithmetic operation.

When an arithmetic operation is started, in a first cycle, an arithmetic operator 100 at a left end and an upper end executes the arithmetic operation by using data input from the left side and the upper side. The arithmetic operator 100 at the left end and the upper end is referred to as a first arithmetic operator. As indicated by a state 101 in FIG. 2, the first arithmetic operator outputs an arithmetic operation result to an arithmetic operator 100 adjacent on the right side and an arithmetic operator 100 adjacent on the lower side. In a next cycle, the first arithmetic operator receives an input of next data from the upper side and next data from the left side. The first arithmetic operator executes a next arithmetic operation by using the data input in one cycle. In this cycle, the arithmetic operator 100 adjacent on the lower side of the first arithmetic operator executes the arithmetic operation by using data input from a buffer memory on the left side and the data input from the first arithmetic operator. The arithmetic operator 100 adjacent on the right side of the first arithmetic operator executes the arithmetic operation by using the data input from the first arithmetic operator and data input from a buffer memory on the upper side.

Thereafter, for each cycle, a front line of the arithmetic operators 100 that execute the arithmetic operation propagates in a direction of a diagonal line toward the lower right, and the behavior of the systolic array 10 transitions to a state 102. Thereafter, when the cycle further progresses, the front line of the arithmetic operators 100 that execute the arithmetic operation moves in the direction of the diagonal line toward the lower right, and the behavior of the systolic array 10 transitions to a state 103. When the data for executing the arithmetic operation indicated by the oblique line pattern is further followed by data for the arithmetic operation, arithmetic operators 100 indicated by a dot pattern in the state 103 execute the next arithmetic operation. When the data for executing the arithmetic operation indicated by the oblique line pattern is not followed by data for the arithmetic operation, the arithmetic operators 100 indicated by the dot pattern in the state 103 do not perform the arithmetic operation. The arithmetic operation by the entire arithmetic operation matrix performed by the arithmetic operators 100 propagating the arithmetic operation result corresponds to an example of a “matrix arithmetic operation”, and the arithmetic operation executed by each arithmetic operator 100 corresponds to an example of an “individual arithmetic operation”.

The power supply to the arithmetic operator 100 and the operation start in a case of performing the arithmetic operation as in the related art, which is different from the systolic array 10 according to the present embodiment, will be described. In this case, a problem occurs because an error occurs due to an influence of the IR drop.

In this case, each arithmetic operator 100 in each of the states 101 to 103 in FIG. 2 is supplied with power at the timing at which the state in which the pattern is not added changes to the state in which the oblique line pattern is added, and starts operation. In this case, a most dangerous timing at which the IR drop due to the operation start of each arithmetic operator 100 is the maximum is the timing of the state 102, which is a case where the arithmetic operators 100 over the diagonal line coupling the right end and the upper end to the left end and the lower end all start operating at the same time.

This is the same even when the number of arithmetic operators 100 included in the arithmetic operation matrix is different, and the timing at which the arithmetic operators 100 over the diagonal line in the arithmetic operation matrix formed by the arithmetic operators 100 all start operating at the same time is the most dangerous. For example, the number of arithmetic operators 100 over the diagonal line in the arithmetic operation matrix is a maximum newly operating number.

For example, in a case of a 32×32 arithmetic operation matrix when the size of the matrix is represented by a product of the individual numbers, a maximum of 32 arithmetic operators are newly operated. In a case of a 128×128 arithmetic operation matrix, a maximum of 128 arithmetic operators are newly operated. In a case of a 512×512 arithmetic operation matrix, a maximum of 512 arithmetic operators are newly operated. When arithmetic operators of the maximum newly operating number are operated, there is a highest possibility that the error occurs due to the influence of the IR drop.

Therefore, the systolic array 10 according to the present embodiment receives an instruction to start idling of the arithmetic operator 100 from the control unit 13. The idling is a pre-operation of the arithmetic operator 100 in which power is supplied to the arithmetic operator 100 in advance to start operation and set the arithmetic operator 100 in an operating state. For example, a signal line connected to the systolic array 10 from the control unit 13 for transmitting a valid (VLD) signal which is a circuit operation valid signal is disposed in the processor 1. When a value of the VLD signal sent from the control unit 13 via the signal line is 0, it is a state in which the idling instruction has not been received. When the value of the VLD signal changes to 1, the systolic array 10 determines that the idling instruction of the arithmetic operator 100 has been received.

Upon receiving the idling instruction of the arithmetic operator 100, the systolic array 10 supplies power to a newly issuable arithmetic operator number of arithmetic operators 100 for each cycle to sequentially start operation. The newly issuable arithmetic operator number is an upper limit number of arithmetic operators 100 to be caused to newly start operation in order to avoid the occurrence of the IR drop.

In the case of idling, the arithmetic operator 100 executes a dummy arithmetic operation after the power supply. In this case, the arithmetic operator 100 discards calculation data. By idling and pre-operating the arithmetic operator 100, the systolic array 10 does not have to supply power to the arithmetic operator 100 to start activation of the arithmetic operator 100 at the time point of using the arithmetic operator 100 for the arithmetic operation, and thus a stall may be avoided.

The systolic array 10 executes the arithmetic operation when data is input from the memory 11 after the execution of idling of the arithmetic operator 100. When the arithmetic operation is performed, the arithmetic operation is executed by using the arithmetic operators 100 in a normal order illustrated in FIG. 2. In this case, when the arithmetic operator 100 to be used has not been idled, the systolic array 10 supplies power to the arithmetic operator 100 to start operation and then causes the arithmetic operator 100 to execute the arithmetic operation. When the arithmetic operator 100 to be used has been idled, the systolic array 10 causes the pre-operated arithmetic operator 100 to execute the arithmetic operation as it is.

In this way, in the systolic array 10, a plurality of arithmetic operators 100 are arranged in a matrix, and a matrix arithmetic operation is executed by causing each of the arithmetic operators 100 to sequentially perform different individual arithmetic operations. More specifically, the systolic array 10 operates arithmetic operators 100 equal to or less than an upper limit number for each cycle, and inputs data held by the memory 11 or data propagated from the adjacent arithmetic operator 100 to one or a plurality of arithmetic operators 100 that have already been operated for each cycle to perform the individual arithmetic operations. The systolic array 10 repeatedly propagates the arithmetic operation result to the adjacent arithmetic operators 100 to execute the matrix arithmetic operation. The systolic array 10 pre-operates in order from arithmetic operators 100 close to one diagonal line of the matrix among the arithmetic operators 100 arranged in the matrix. The systolic array 10 allocates the arithmetic operators 100 to be caused to execute the individual arithmetic operations for each cycle from among the arithmetic operators 100 that have been caused to start operation in each cycle and the arithmetic operators 100 that have been pre-operated.

When the arithmetic operation by the arithmetic operation matrix ends, the arithmetic operator 100 outputs the arithmetic operation result to the memory 11. Next, the arithmetic operator 100 notifies the control unit 13 of the completion of the arithmetic operation.

The instruction issuing unit 12 receives an input of the execution instruction of the arithmetic operation using the systolic array 10, such as a matrix arithmetic operation, from an external processor or the like. Next, the instruction issuing unit 12 notifies the control unit 13 of the acquired execution instruction and causes the control unit 13 to start management for each processing.

The control unit 13 receives the input of the execution instruction of the arithmetic operation from the instruction issuing unit 12. Next, the control unit 13 instructs an external memory 2 to transmit data to be used for the designated arithmetic operation, and causes the external memory 2 to transmit the data to be used for the arithmetic operation to each memory 11.

Thereafter, the control unit 13 receives, from each memory 11, a notification of a reception completion timing calculated at the start of data reception by the memory 11. The reception completion timing is a time until the reception of all pieces of data predicted by the memory 11 at the start of reception is finished, and is, for example, a number of cycles until the reception completion. When the reception completion timing is N cycles, the control unit 13 receives logN (bit) information. For example, when a packet-data length is 8/16/32/64 cycles, the control unit 13 receives the notification of the reception completion timing by a three-bit signal including a one-bit VLD and a two-bit compressed packet. The information on the reception completion timing is stored in a packet header or the like.

The control unit 13 sets a latest reception completion timing among the reception completion timings of all the memories 11 as a reception completion timing of the entire memory 11 in which all the pieces of data to be used for the execution of the arithmetic operation are prepared. The control unit 13 calculates a reception completion time from the reception completion timing of the entire memory 11. Since the memory 11 receives a large amount of data, it takes a large number of cycles from the start of reception to the reception completion. Therefore, the control unit 13 may acquire the information on the reception completion timing with a sufficient margin before the reception completion.

Next, the control unit 13 calculates an elapsed time until the systolic array 10 starts the arithmetic operation after the data to be used for the execution of the designated arithmetic operation is prepared in each memory 11. The control unit 13 may hold information of the elapsed time for each type of the arithmetic operation in advance, or may calculate the elapsed time from a content of the arithmetic operation.

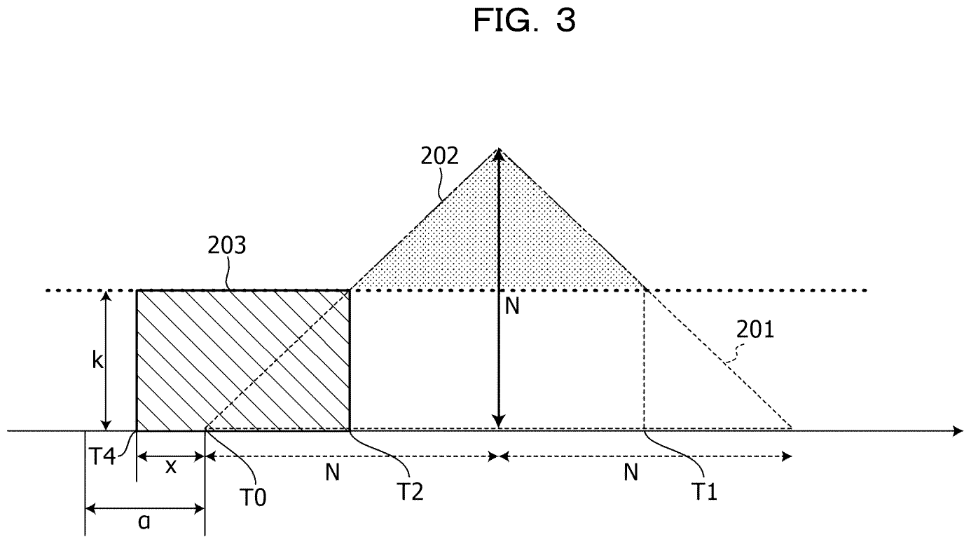

FIG. 3 is a diagram for describing idling control by the control unit. In FIG. 3, a horizontal axis represents the elapsed time in units of one cycle, and a vertical axis represents a number of operating arithmetic operators 100. In FIG. 3, the elapsed time is α. The control unit 13 calculates an arithmetic operation start time by adding the elapsed time to the reception completion time at which all pieces of data to be used for the execution of the arithmetic operation are prepared. In FIG. 3, the arithmetic operation start time is a time TO

The control unit 13 calculates a requested arithmetic operator number, which is a number of all the arithmetic operators 100 to be used for the execution of the arithmetic operation, from the designated arithmetic operation. The control unit 13 may hold information on the requested arithmetic operator number of arithmetic operators 100 to be used for each type of the arithmetic operation in advance, or may calculate the requested arithmetic operator number of arithmetic operators 100 to be used from the content of the arithmetic operation.

For example, when the arithmetic operators 100 forming the arithmetic operation matrix of N rows and N columns are used for the arithmetic operation, the control unit 13 calculates the requested arithmetic operator number as N². In the systolic array 10, the number of arithmetic operators 100 to be used increases in proportion to each cycle from the start of the arithmetic operation, and decreases in proportion to each cycle when the diagonal line of the matrix is exceeded. In FIG. 3, since the arithmetic operation is started at the time TO, the requested arithmetic operator number is represented by an area of a triangle 201 surrounded by broken lines in FIG. 3.

The control unit 13 holds a newly issuable arithmetic operator number in advance. In FIG. 3, the newly issuable arithmetic operator number is k. The control unit 13 determines whether or not a maximum operation start number of arithmetic operators 100 in the arithmetic operation to be executed is equal to or less than the newly issuable arithmetic operator number. The maximum operation start number of arithmetic operators 100 in the arithmetic operation to be executed is the number of rows or columns of the arithmetic operation matrix, and is N in FIG. 3. When the maximum operation start number of arithmetic operators 100 is equal to or less than the newly issuable arithmetic operator number, the operation start number of arithmetic operators 100 in each cycle falls within the newly issuable arithmetic operator number. Therefore, the control unit 13 determines that idling is unnecessary, and waits until all the memories 11 complete reception of data.

On the other hand, when the maximum operation start number of arithmetic operators 100 is larger than the newly issuable arithmetic operator number, the control unit 13 executes the following idling control processing. When the arithmetic operators 100 to be used are sequentially operated, a portion exceeding the newly issuable arithmetic operator number k in the triangle 201 of FIG. 3 is a portion in which the operation is delayed. The timing at which the arithmetic operators 100 whose operation is delayed are most accumulated is a time T1 in FIG. 3. In this case, when the operation of all the arithmetic operators 100 used for the arithmetic operation are in time by the time T1, it is possible to avoid the occurrence of the arithmetic operators 100 whose operation is delayed, for example, the stall of the arithmetic operation executed by the arithmetic operators 100.

For this purpose, the control unit 13 may start the operation of the arithmetic operators 100 of the number in which the stall is expected to occur by a time T2. For example, the arithmetic operators 100 of the number included in a region 202 exceeding the newly issuable arithmetic operator number k in the triangle 201 may start operation by the time T2. Hereinafter, the number of arithmetic operators 100 whose operation is delayed and the number of arithmetic operators 100 requested to be pre-operated are referred to as a “requested total number”. The requested total number corresponds to a sum of an excess arithmetic operator number which is the number of arithmetic operators 100 exceeding the newly issuable arithmetic operator number among the arithmetic operators 100 to be newly used in the arithmetic operation in each cycle from the start to the end of the arithmetic operation.

The control unit 13 calculates the requested total number by using the requested arithmetic operator number and the newly issuable arithmetic operator number k. For example, as illustrated in FIG. 3, the requested total number is the number of arithmetic operators 100 included in the region 202, and when the requested total number is A, the control unit 13 calculates the requested total number as A=N²−0.5×k².

In order to activate the same number of arithmetic operators 100 as the requested total number by the time T2, the control unit 13 obtains a region 203 in which the number of arithmetic operators 100 included in the region 202 matches the number of arithmetic operators 100 included therein, by using the newly issuable arithmetic operator number k. Hereinafter, the number of arithmetic operators 100 included in the region 203, which is the number of arithmetic operators 100 whose operation is started in advance, is referred to as a total newly issuable number. In FIG. 3, the control unit 13 calculates the total newly issuable number as B=k (k+x), when B is the total newly issuable number. x is a limit time during which all of the requested total number of arithmetic operators 100 may be operated.

The control unit 13 calculates x at which the numbers of arithmetic operators 100 included in the region 202 and the region 203 match, for example, x at which A, which is the requested total number, matches B, which is the total newly issuable number. When x may not be calculated as an integer, the control unit 13 calculates a minimum x at which the total newly issuable number B exceeds the requested total number A. In this case, the control unit 13 subtracts the time before x from the operation start time T0 to calculate a limit time T4 at which all of the requested total number of arithmetic operators 100 may be operated.

Next, the control unit 13 compares the limit time T4 with a current time. When the current time has passed the limit time T4, the control unit 13 determines that it is not possible to operate all of the requested total number of arithmetic operators 100 in time, and determines to immediately start operation of the newly issuable arithmetic operator number k. The control unit 13 instructs the systolic array 10 to start idling of the arithmetic operators 100 of the newly issuable arithmetic operator number k.

When the limit time T4 and the current time match, the control unit 13 determines to immediately start the operation of the newly issuable arithmetic operator number k. The control unit 13 instructs the systolic array 10 to start idling of the arithmetic operators 100 of the newly issuable arithmetic operator number k.

When the limit time T4 is later than the current time, the control unit 13 waits until the limit time T4 at which all of the requested total number of arithmetic operators 100 may be operated. When the current time reaches the limit time T4, the control unit 13 instructs the systolic array 10 to start idling of the arithmetic operators 100 of the newly issuable arithmetic operator number k.

The control unit 13 may use the one-bit VLD signal as described above, as a method for instructing the systolic array 10 to start idling. For example, when the idling is not performed, the control unit 13 continuously inputs the VLD signal having a value of 0 to the systolic array 10 by using an idling signal line. When instructing the start of idling, the control unit 13 uses the idling signal line to input the VLD signal having a value of 1 to the systolic array 10 until the arithmetic operation is completed.

Thereafter, the control unit 13 receives a notification of reception completion from each memory 11. Upon receiving the notification of the reception completion from all the memories 11, the control unit 13 instructs each memory 11 to perform data transfer. Thereafter, the control unit 13 notifies the systolic array 10 of the start of the arithmetic operation. When the arithmetic operation is completed, the control unit 13 receives a notification of the arithmetic operation completion from the systolic array 10. The control unit 13 ends the control of the arithmetic operation.

In this way, the control unit 13 receives the processing request of the matrix arithmetic operation and calculates, for each cycle, the excess arithmetic operator number which is the number of arithmetic operators 100 that exceed the upper limit number to be caused to newly start operation among increments of the arithmetic operators 100 to be caused to perform the individual arithmetic operations for each cycle. Next, based on the start of data reception of the memory 11, the control unit 13 causes the arithmetic operators 100 to pre-operate based on the excess arithmetic operator number. When the memory 11 completes the reception of the data, the control unit 13 causes the systolic array 10 to execute the matrix arithmetic operation based on the data held by the memory 11. The control unit 13 calculates the time taken for the pre-operation of the excess arithmetic operator number of arithmetic operators 100 based on the newly issuable arithmetic operator number which is the upper limit number, and calculates a pre-operation start timing based on the reception completion timing. When the pre-operation start timing has already arrived at the time of calculation of the pre-operation start timing, the control unit 13 starts the pre-operation at that time point. When the pre-operation start timing has not yet arrived, the control unit 13 starts the pre-operation after waiting until the pre-operation start timing.

As the memory 11, a random-access memory (RAM) may be used. Each memory 11 receives an input of data to be used for an arithmetic operation from the external memory 2. In this way, the memory 11 sequentially receives and stores data used for a matrix arithmetic operation that includes a plurality of individual arithmetic operations.

Next, each memory 11 calculates a reception completion timing at the start of data reception. Each memory 11 notifies the control unit 13 of the calculated reception completion timing. In this way, the memory 11 predicts the data reception completion timing at the start of the data reception and notifies the control unit 13 of the data reception completion timing.

Thereafter, each memory 111 notifies the control unit 13 of reception completion when the reception of all pieces of data addressed to itself and to be used for the arithmetic operation is completed. Thereafter, upon receiving a data transfer instruction from the control unit 13, each memory 111 outputs the data to be used for the arithmetic operation to the systolic array 10.

Next, a specific operation of executing idling of the arithmetic operator 100 in the systolic array 10 will be described. When the limit time is before the current time, it is not possible to operate all of the requested total number of arithmetic operators 100 in time. Therefore, the systolic array 10 starts operation of as many the arithmetic operators 100 as possible that correspond to the timing at which the operation start number increases. The timing at which the operation start number becomes the maximum is the operation start time of the arithmetic operators 100 over the diagonal line. For example, the systolic array 10 starts operation from the arithmetic operators 100 as close to the diagonal line as possible. Even when the limit time is after the current time, it is preferable that the systolic array 10 operates the arithmetic operators 100 in the same procedure in order to ensure safety.

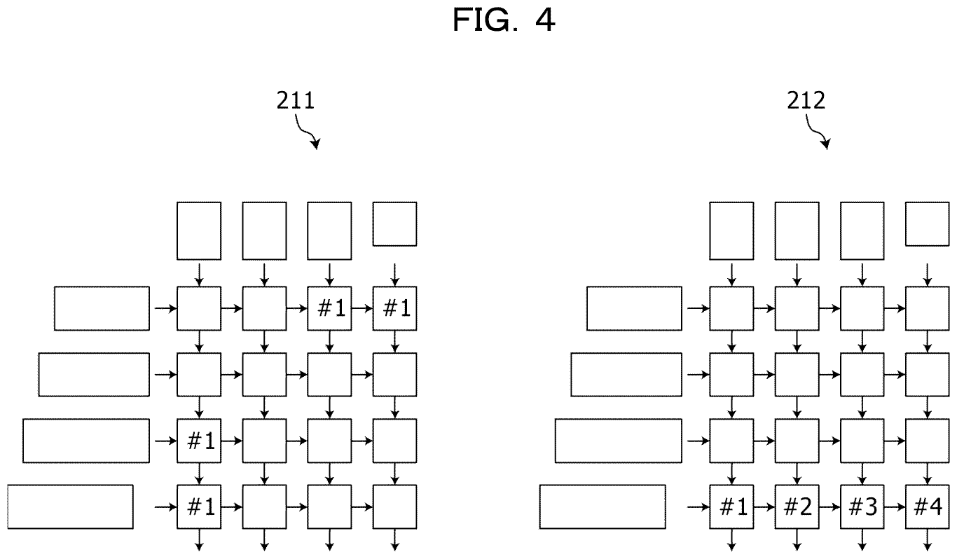

FIG. 4 is a diagram illustrating an example of an outline of an idling order. A case where the arithmetic operation matrix is 4×4 and the newly issuable arithmetic operator number is four will be described.

The arithmetic operator 100 starts operation when dummy data is input. Therefore, the arithmetic operator 100 that may start operation is the arithmetic operator 100 connected to the buffer memory or the arithmetic operator 100 connected to the arithmetic operator 100 that is already operating. For example, as indicated in a state 211, first, the systolic array 10 may start operation of a total of four arithmetic operators which are two arithmetic operators 100 connected to the respective buffer memories over the diagonal line and two arithmetic operators 100 connected to the respective adjacent buffer memories. For example, the systolic array 10 starts the operation of the arithmetic operators 100 to which a number #1 is assigned in the state 211.

The systolic array 10 moves the arithmetic operators 100 to be started to operate to the output side for each cycle. For example, as indicated in a state 212, the systolic array 10 moves the positions of the arithmetic operators 100 to be started to operate for each cycle in an order of the numbers #1 to #4. In a case where the number of operable arithmetic operators 100 is insufficient, the systolic array 10 activates arithmetic operators 100 that are closest to the diagonal line and are connected to the respective buffer memories among arithmetic operators 100 that have not started activation.

The systolic array 10 operates as many of the arithmetic operators 100 of the newly issuable arithmetic operator number as possible. However, when the number of operable arithmetic operators 100 is less than the newly issuable arithmetic operator number due to the propagation state of the dummy data or the like, the systolic array 10 operates as many arithmetic operators 100 as possible, which is less than the newly issuable arithmetic operator number.

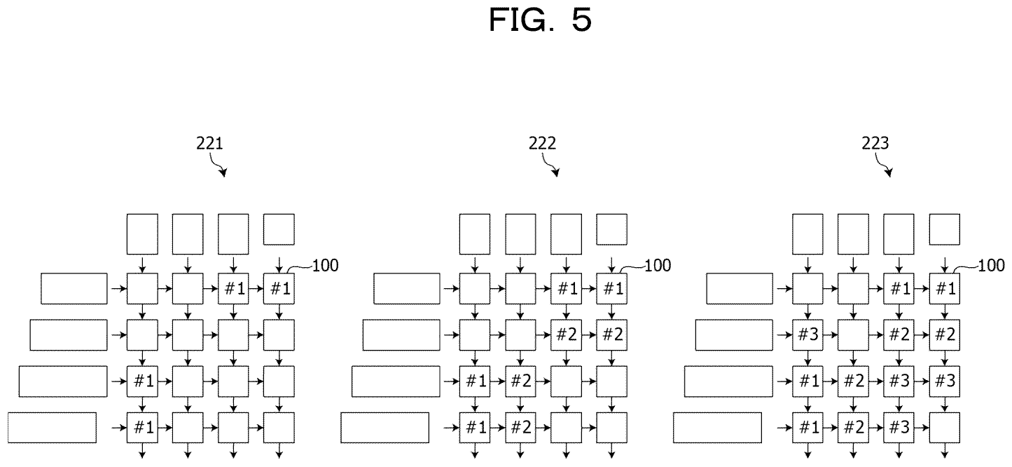

FIG. 5 is a diagram illustrating an example of a specific idling order. Upon receiving the idling instruction from the control unit 13, the systolic array 10 starts operation of the arithmetic operators 100 to which the number #1 is assigned as indicated in a state 221. In the next cycle, the systolic array 10 starts operation of the arithmetic operators 100 to which the number #2 is assigned as indicated in a state 222. In the next cycle, the systolic array 10 starts operation of the arithmetic operators 100 to which the number #3 is assigned as indicated in a state 223.

The systolic array 10 may reduce the occurrence of the stall as much as possible by idling the arithmetic operators 100 in this way even when it is not possible to operate all of the requested total number of arithmetic operators 100 in time. However, in the systolic array 10 according to the present embodiment, in a case where it is not possible to operate all of the requested total number of arithmetic operators 100 in time, the stall occurs for the arithmetic operation performed by the arithmetic operators 100 of the number that have not been able to be operated in time.

Although the operation of the arithmetic operators 100 is started in the same order even when the limit time is after the current time for the sake of safety, the activation order may be another order as long as it is sufficiently in time.

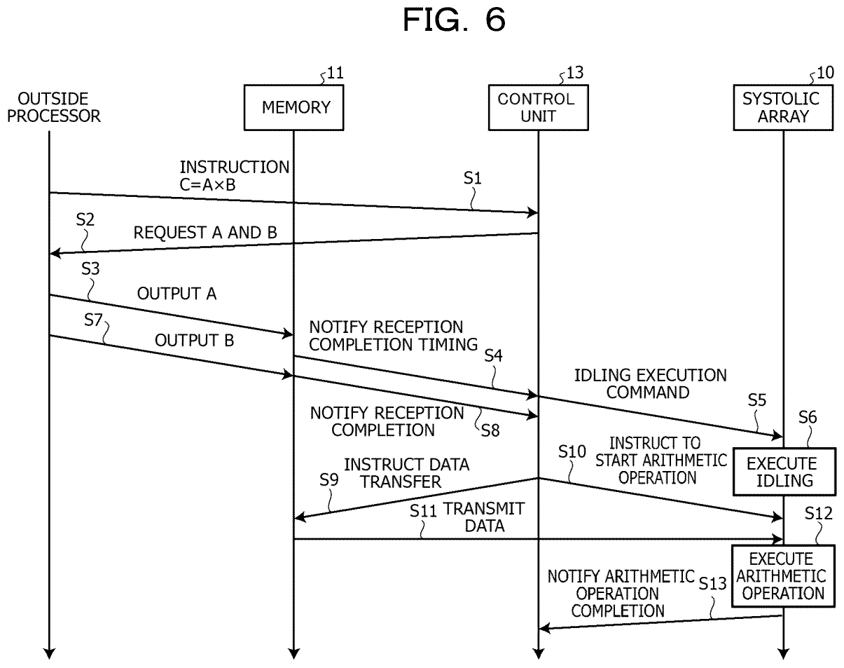

FIG. 6 is a sequence diagram of the arithmetic operation execution by the processor according to the embodiment. Next, an overall flow of the arithmetic operation execution by the processor 1 according to the embodiment will be described with reference to FIG. 6. A case where the memories 11 are collectively considered as one memory and an arithmetic operation of calculating C, which is C=A×B is executed will be described as an example. It is assumed that A and B are two pieces of data. The operation of the instruction issuing unit 12 is omitted.

The control unit 13 acquires an execution instruction for the arithmetic operation of C=A×B (step S1). The control unit 13 requests the external memory 2 for the data A and B (step S2).

In response to the request from the control unit 13, the external memory 2 sequentially returns responses for the data A and B. For example, the external memory 2 outputs the data A and sends it to the memory 11 (step S3). Upon receiving the data A, the memory 11 calculates a reception completion timing and notifies the control unit 13 of the reception completion timing (step S4).

Upon receiving the notification of the reception completion timing, the control unit 13 determines whether or not to execute idling. When the idling is executed, the control unit 13 transmits an idling execution command to the systolic array 10 and instructs the execution of idling (step S5). The idling execution command is sent, for example, as a one-bit VLD signal through a dedicated signal line. Upon receiving the idling execution command, the systolic array 10 executes idling of the newly issuable arithmetic operator number of arithmetic operators 100 for each cycle (step S6).

Meanwhile, the external memory 2 outputs the data B and sends it to the memory 11 (step S7). Upon receiving both the data A and B, the memory 11 notifies the control unit 13 of reception completion (step S8).

Upon receiving the notification of the reception completion, the control unit 13 instructs the memory 11 to perform data transfer (step S9). The control unit 13 instructs the systolic array 10 to start an arithmetic operation (step S10).

The memory 11 transmits the data to the systolic array 10 (step S11). The systolic array 10 executes the arithmetic operation by using the received data (step S12).

Thereafter, when the arithmetic operation ends, the systolic array 10 notifies the control unit 13 of completion of the arithmetic operation (step S13).

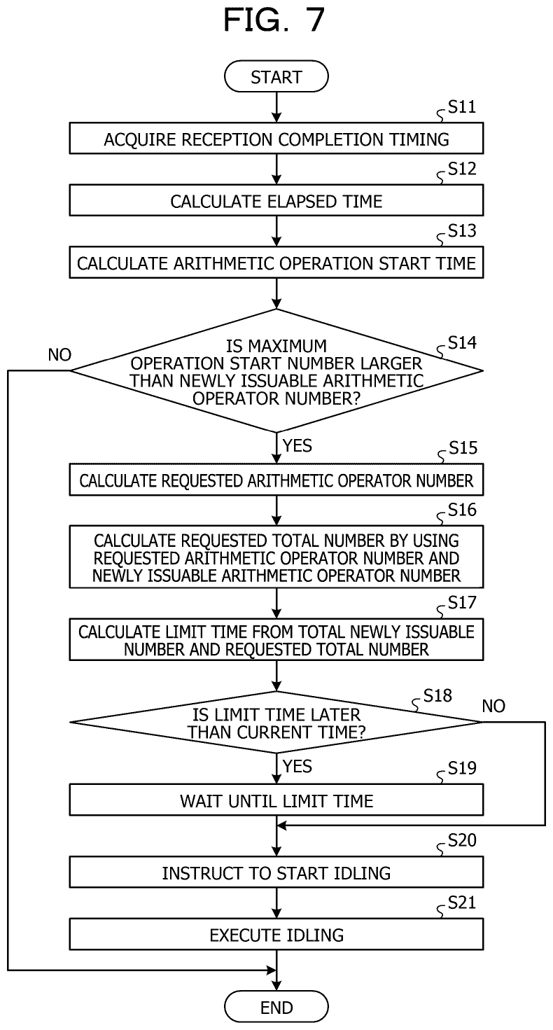

FIG. 7 is a flowchart of idling control. Next, a detailed flow of the idling control by the control unit 13 will be described with reference to FIG. 7.

The control unit 13 receives, from each memory 11, a notification of the reception completion timing calculated at the start of the data reception. The control unit 13 sets a latest reception completion timing among the reception completion timings of all the memories 11 as the reception completion timing of the entire memory 11 (step S11).

Next, the control unit 13 calculates an elapsed time from when the data to be used for executing the designated arithmetic operation is prepared in each memory 11 to when the systolic array 10 starts the arithmetic operation (step S12).

Next, the control unit 13 calculates an arithmetic operation start time by adding the elapsed time to the reception completion timing of the entire memory 11 (step S13).

Next, the control unit 13 determines whether or not a maximum operation start number of arithmetic operators 100 in the arithmetic operation to be executed is equal to or less than a newly issuable arithmetic operator number (step S14). When the maximum operation start number of arithmetic operators 100 is equal to or less than the newly issuable arithmetic operator number (step S14: No), the control unit 13 determines that idling is unnecessary, and ends the idling control.

On the other hand, when the maximum operation start number of arithmetic operators 100 is larger than the newly issuable arithmetic operator number (step S14: Yes), the control unit 13 calculates a requested arithmetic operator number, which is the number of all arithmetic operators 100 to be used to execute the arithmetic operation, from the designated arithmetic operation (step S15).

Next, the control unit 13 calculates a requested total number by using the requested arithmetic operator number and the newly issuable arithmetic operator number (step S16).

Next, the control unit 13 calculates a time until the arithmetic operation start time at which a total newly issuable number represented by using the newly issuable arithmetic operator number and the requested total number match. The control unit 13 subtracts the calculated time from the arithmetic operation start time to calculate a limit time at which all of the requested total number of arithmetic operators 100 may be operated (step S17).

Next, the control unit 13 determines whether or not the limit time is later than a current time (step S18). When the limit time is earlier than the current time (step S18: No), the control unit 13 proceeds to step S20.

On the other hand, when the limit time is later than the current time (step S18: Yes), the control unit 13 waits until the limit time (step S19).

Thereafter, the control unit 13 instructs the systolic array 10 to start idling of the arithmetic operators 100 of the newly issuable arithmetic operator number k (step S20).

The systolic array 10 executes idling in response to the instruction from the control unit 13 (step S21).

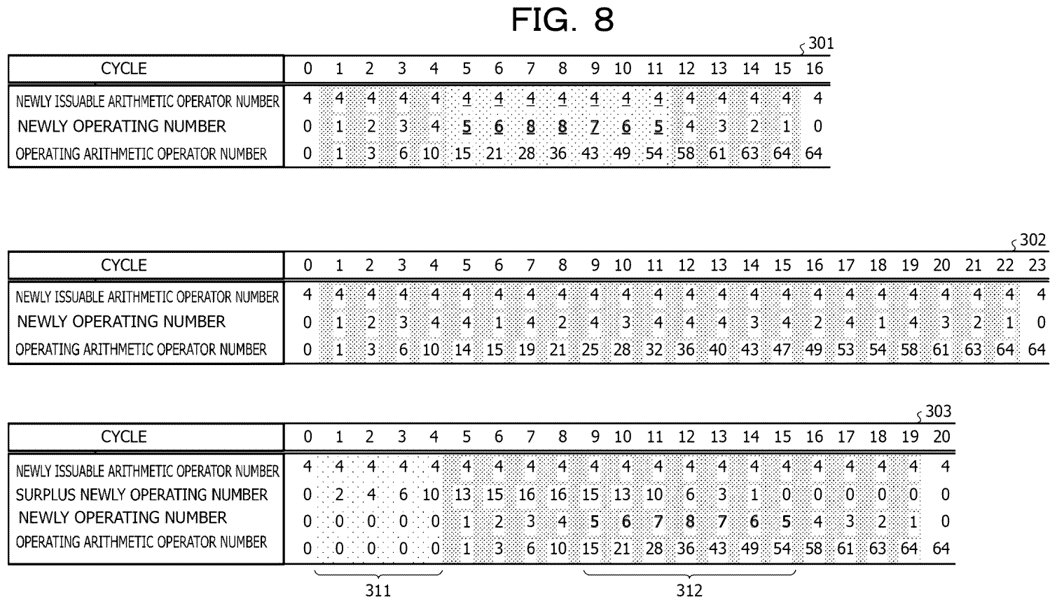

FIG. 8 is a diagram illustrating a comparison of the time taken to execute the arithmetic operation between the processor according to the embodiment and a processor that does not perform idling. Next, an effect of the processor 1 according to the present embodiment will be described with reference to FIG. 8. A case where an 8×8 matrix arithmetic operation is executed by using an 8×8 arithmetic operation matrix will be described. In this case, the newly issuable arithmetic operator number is four.

A table 301 indicates an execution result of the arithmetic operation when a limit is not set on the newly issuable arithmetic operator number. In the table 301, the newly issuable arithmetic operator number is described as a comparison with the newly operating number, but the newly issuable arithmetic operator number is not limited. In this case, the arithmetic operation is started from the first cycle, and the arithmetic operation ends at the fifteenth cycle. However, actually, the newly issuable arithmetic operator number is exceeded in the fifth to eleventh cycles, and the IR drop occurs during this period.

Therefore, when the same arithmetic operation as that in the table 301 is performed by setting a limit on the newly issuable arithmetic operator number without idling, an execution result as indicated in a table 302 is obtained. In this case, the stall of the arithmetic operation by the arithmetic operators 100 that do not start operation for the fifth to eleventh cycles occurs. Therefore, it takes 22 cycles to complete the arithmetic operation.

On the other hand, the case where the processor 1 according to the present embodiment is used is indicated in a table 303. In this case, the systolic array 10 executes, in a range 311 corresponding to the first to fourth cycles, the idling of the arithmetic operators 100 in excess of the newly issuable arithmetic operator number in a range 312 corresponding to the ninth to fifteenth cycles. Therefore, in the processor 1 according to the present embodiment, the time for operating the arithmetic operators 100 is 19 cycles, but the time for executing the arithmetic operation is 15 cycles because four cycles of the range 311 are hidden. Therefore, by using the processor 1 according to the present embodiment, it is possible to complete the arithmetic operation in a time equivalent to that in the case where no limit is set on the newly issuable arithmetic operator number. In this way, by using the processor 1 according to the present embodiment, it is possible to reduce a decrease in speed in a case where a limit is set on the newly issuable arithmetic operator number without idling.

As described above, the processor according to the present embodiment causes the systolic array to idle as many arithmetic operators as the number of arithmetic operators predicted to cause the stall due to the limit on the newly issuable arithmetic operator number provided to avoid the IR drop, and causes the arithmetic operators to execute the arithmetic operation. As a result, the occurrence of the stall may be reduced, and the delay in the arithmetic operation time may be suppressed. Therefore, it is possible to suppress the occurrence of the stall while reducing the occurrence of the IR drop, and it is possible to maintain processing performance and improve reliability. For example, the processor according to the present embodiment exerts an effect when a floating-point arithmetic operation with large power consumption is targeted. The processor according to the present embodiment may suppress power consumption by waiting for the timing at which the pre-operation is started until the latest timing at which the operations of the arithmetic operators corresponding to the number of arithmetic operators in which the stall is predicted to occur may be completed.

For example, the number of arithmetic operators of the systolic array continues to increase, such as 32×32=256, 64×64=512, and 128×128=16384. On the other hand, the number of arithmetic operators requested in the latest application reaches as much as 2048×2048. Therefore, the risk of the IR drop is very high, and when the operation start number at the same timing is simply limited, a large number of stalls occur, and the processing delay increases. The processor according to the present embodiment may exert a higher effect in the execution of the latest application using the systolic array having such a large number of arithmetic operators, and may maintain the processing performance and improve the reliability.

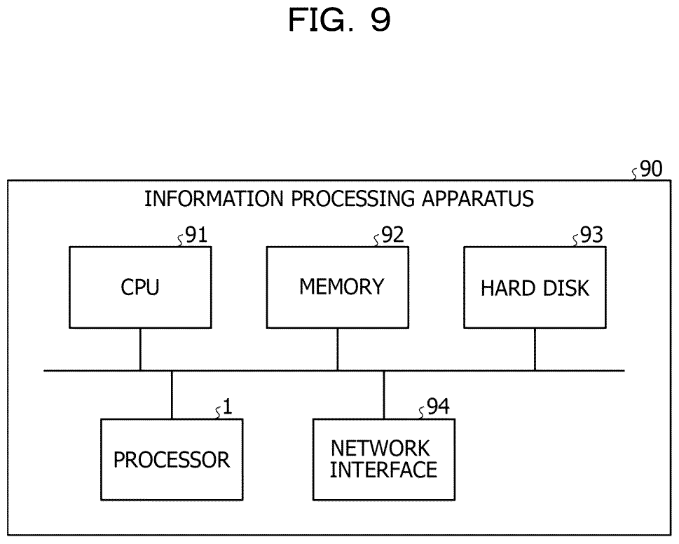

FIG. 9 is a diagram illustrating an example of hardware of an information processing apparatus equipped with the processor according to the embodiment. For example, an information processing apparatus 90 includes the processor 1, a central processing unit (CPU) 91, a memory 92, a hard disk 93, and a network interface 94. The CPU 91 is coupled to the processor 1, the memory 92, the hard disk 93, and the network interface 94 via a bus.

The network interface 94 relays communication between the CPU 91 and an external device. The hard disk 93 is an auxiliary storage device, and stores various programs such as an operating system (OS) and applications.

The memory 92 is various storage devices and is, for example, a random-access memory (RAM). The memory 92 realizes the function of the external memory 2 in FIG. 1. The memory 92 corresponds to an example of a “main memory”.

The CPU 91 reads various programs stored in the hard disk 93, develops the programs in the memory 92, and executes the programs. The CPU 91 instructs the processor 1 to perform a matrix arithmetic operation or the like in the execution of the programs. The CPU 91 acquires the result of the arithmetic operation executed by the systolic array 10 of the processor 1 using the data or the like stored in the memory 92, and executes the programs. This CPU 91 corresponds to an example of a “main arithmetic operator”.

The processor 1 may be coupled to the CPU 91 by using a host interface or the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic device comprising:
a memory configured to sequentially receive and store data to be used for a matrix arithmetic operation that includes a plurality of individual arithmetic operations;
a systolic array in which a plurality of arithmetic operators are arranged in a matrix, and configured to execute the matrix arithmetic operation by causing the arithmetic operators to perform different individual arithmetic operations in order; and
a processor configured to, upon receiving a processing request for the matrix arithmetic operation, calculate, for each cycle, an excess arithmetic operator number which is a number of arithmetic operators that exceed an upper limit number to be caused to newly start operation among increments of the arithmetic operators to be caused to perform the individual arithmetic operations for each cycle, pre-operate the arithmetic operators based on the excess arithmetic operator number based on start of data reception of the memory, and cause the systolic array to execute the matrix arithmetic operation based on the data held by the memory when the memory completes the data reception.

2. The arithmetic device according to claim 1, wherein
the systolic array executes the matrix arithmetic operation by repeatedly operating the arithmetic operators equal to or less than the upper limit number for each cycle, inputting the data held by the memory or data propagated from adjacent arithmetic operators to one or a plurality of arithmetic operators that have already been operated for each cycle to perform the individual arithmetic operations, and propagating an arithmetic operation result to adjacent arithmetic operators.

3. The arithmetic device according to claim 1, wherein
the systolic array pre-operates the arithmetic operators in order from arithmetic operators close to one diagonal line of the matrix among the arithmetic operators arranged in the matrix.

4. The arithmetic device according to claim 1, wherein
the systolic array allocates the arithmetic operators to be caused to execute the individual arithmetic operations for each cycle from among the arithmetic operators that have been caused to start operation in each cycle and the arithmetic operators that have been pre-operated.

5. The arithmetic device according to claim 1, wherein
the memory predicts a data reception completion timing at the start of the data reception and notifies the processor of the data reception completion timing, and
the processor calculates a time taken for the pre-operation of the excess arithmetic operator number of arithmetic operators based on the upper limit number, and calculates a pre-operation start timing based on the reception completion timing.

6. The arithmetic device according to claim 5, wherein
when the pre-operation start timing is calculated, in a case where the pre-operation start timing has already arrived, the processor starts the pre-operation at that time point, and in a case where the pre-operation start timing has not yet arrived, the processor waits until the pre-operation start timing and then starts the pre-operation.

7. An information processing apparatus comprising:
a memory configured to sequentially receive and store data to be used for a matrix arithmetic operation that includes a plurality of individual arithmetic operations;
a systolic array in which a plurality of arithmetic operators are arranged in a matrix, and configured to execute the matrix arithmetic operation by causing the arithmetic operators to perform different individual arithmetic operations in order; and
a processor configured to, upon receiving a processing request for the matrix arithmetic operation, calculate, for each cycle, an excess arithmetic operator number which is a number of arithmetic operators that exceed an upper limit number to be caused to newly start operation among increments of the arithmetic operators to be caused to perform the individual arithmetic operations for each cycle, pre-operate the arithmetic operators based on the excess arithmetic operator number based on start of data reception of the memory, and cause the systolic array to execute the matrix arithmetic operation based on the data held by the memory when the memory completes the data reception.

8. A method for controlling an arithmetic device including a memory configured to sequentially receive and store data to be used for a matrix arithmetic operation that includes a plurality of individual arithmetic operations and a systolic array in which a plurality of arithmetic operators are arranged in a matrix, and configured to execute the matrix arithmetic operation by causing the arithmetic operators to perform different individual arithmetic operations in order, the method comprising:
upon receiving a processing request for the matrix arithmetic operation, calculating, for each cycle, an excess arithmetic operator number which is a number of arithmetic operators that exceed an upper limit number to be caused to newly start operation among increments of the arithmetic operators to be caused to perform the individual arithmetic operations for each cycle;
pre-operating the arithmetic operators based on the excess arithmetic operator number based on start of data reception of the memory; and
causing the systolic array to execute the matrix arithmetic operation based on the data held by the memory when the memory completes the data reception.
